(19) United States
(12) Patent Application Publication
(10) Pub. No.: US 2012/0185323 A1
(43) Pub. Date: Jul. 19, 2012

(54) In-Store Coupon Delivery System

(76) Inventor: Rami A. Jaber, Cudahy, WI (US)

(21) Appl. No.: 13/006,679

(22) Filed: Jan. 14, 2011

(51) Int. Cl. G06Q 30/00

(52) U.S. Cl. 705/14.38

(57) ABSTRACT

A system and method for delivering coupons to consumers in a retail shopping environment. The system includes an indicator positioned proximate a retail display of a discounted product. A customer directly interacts with an in-store electronic coupon delivery system. The in-store coupon delivery system assesses the products intended to be purchased and generates an output associated with reducing a purchase price by a total amount of a discount price. The output is communicated to a cashier and, upon confirmation of actual purchase of the intended products, the total purchase price is reduced by the total discount amount. The in-store coupon delivery system provides a merchandise discount system that can be quickly and economically configured to satisfy the requirements of a particular retailer and a system that is less susceptible to nefarious interaction such as redemption of invalid coupons.

### BACKGROUND OF THE INVENTION

The present invention relates to merchandise coupon systems, and more specifically, to a coupon system configured to require proactive purchaser interaction and configured to reduce incidents of coupon fraud.

Many product consumers are aware of various means to avoid paying retail purchase price for products. In many consumer product markets, various mechanisms exist which reduce the purchase price of a commodity below a marked price in an effort to sway a consumer's preference for one product over another. Such mechanisms commonly include coupon systems, rebate systems, and/or mechanisms to temporarily reduce the purchase price of a product for a given duration. Each of these price discount systems lend themselves to be more applicable to a particular type or class of commodity as compared to the other price discounting systems.

Rebate systems commonly depend on substantial post purchase activity by the user to effectuate collection of the rebate sum. That is, after a consumer purchases a product, the consumer must commonly provide a manufacturer and/or other third party with an original or a copy of a valid purchase receipt as well as documents related to the rebate itself. Commonly, such rebates also require extended periods of time, commonly 8-12 weeks, for “processing” of the rebate return materials. Only after this duration does the consumer receive the funds associated with the rebate. These supplemental efforts and substantial delays dissuade many consumers from having their purchase swayed by such offers and/or even redeeming such materials. Accordingly, unless the rebate is for a substantial sum, commonly available only for larger purchases such as consumer electronics or other generally one-time purchase items, the rebate process is less than desirable for dissuading a consumer purchase at a point of sale for many direct purchase consumer products such as consumables materials commonly found at grocery stores and/or other points of sale facilities.

Most relatively low price consumer products are commonly discounted by the redemption of vouchers or coupons. Commonly, the coupon has a set value and is valid for a particular duration to reduce the price at which a particular good or commodity can be purchased from a particular retailer. Grocery stores present one venue with a prolific coupon strategy. Commonly, the consumer peruses sales flyers or the like either before or during a shopping experience and selects those products for which the discount associated with a particular product overcomes the user preference for another product and/or for those products that the consumer would regularly purchase regardless of price. During a checkout, the consumer presents those coupons for the products that they have purchased and the total purchase price is reduced according. Such coupon systems have various drawbacks.

The printing and distribution of such coupons present a considerable cost to the presentation of such discounts. Presenting the coupons in a tangible media that the consumer must bring to the retail environment also presents the opportunity that the consumer may forget to bring their selected coupons with them during a shopping event and/or be presented with an unexpected opportunity to address their shopping needs. Such systems are also susceptible to fraud and/or unintended redemption of coupons that are expired, are redeemed for incorrect values, and/or mistakenly redeemed to reduce the purchase price of brands that are not authorized to be reduced by the available coupon. Accordingly, there are a number of advancements that could be provided to such coupon systems.

Others have disclosed providing electronic coupon systems that overcome the detriments associated with such paper coupon systems however, such systems present other drawbacks to the efficient communication, disbursement, and collection of coupon revenues associated with such coupon systems. Some prior art systems provide self-service point of sale or check out devices that automatically adjust purchase prices for available discounts. Still other systems simply discount products by a value rounding metric that manipulates the purchase price to a rounded value derived from the purchase price. The rounded value is subsequently applied as a discount thereby reducing the net purchase price due from the customer. Still other systems disclose paperless coupon systems wherein coupon information is electronically communicated to any of various portable electrical devices associated with customers identified as subscribers to the coupon system. Although such systems overcome a number of the detriments associated with distribution of paper coupons, such systems present their own drawbacks.

For instance, some electronic coupon or product discount systems provide no indication to the purchaser prior to actual purchase of a product as to the amount of the discount. Furthermore, many such systems have fairly high start-up costs associated with converting a paper coupon system into an electronic coupon system. Maintaining the electronic communication of the available coupons between the vender and the retailer also presents the opportunity for nefarious interaction with the coupon system such as “electronic” coupon fraud. Efforts to mitigate such drawbacks commonly require extensive and costly third party management and/or support of such electronic coupon system.

Accordingly, regardless of the type of good or commodity, there is a need for a coupon delivery system wherein information pertinent to the coupon or discount is presented the customer prior to purchase of a product and in a manner that allows customer selection between various products based at least in part on knowledge of the existence and the value of an available discount for a given product. There is a further need for an electronic coupon delivery system that is fully supported and accessible to a customer from within a retail facility. There is a further need for an electronic coupon system that is configured to interact with one or more of the retailer and the supplier so as to assimilate stock data, product life, product information, and customer information to establish coupon availability. There is a further need for an on-sight coupon delivery system that efficiently and economically cooperates with a retailer existing exchange/checkout/register systems.

### SUMMARY OF THE INVENTION

The present invention discloses a system and method for delivering coupons to consumers that overcomes one or more of the drawbacks discussed above. According to one aspect of the invention, a coupon delivery system is disclosed that includes an indicator that is positioned proximate a retail display of a discounted product to inform purchasers of the existence of a discount. A customer directly interacts with an in-store electronic coupon delivery system that assesses the products intended to be purchased and generates an output associated with a reduction of a purchase price of a product by a desired discount amount. The output is communicated to a cashier or other point of sale console and, upon confirmation of the actual purchase of the intended products, the total purchase price is reduced by a total discount amount. The in-store coupon delivery system provides a merchandise discount system that can be quickly and economically configured to satisfy the requirements of a particular retailer and a system that is less susceptible to nefarious actions such as counterfeit coupons and/or other redemptions of invalid coupons.

Another aspect of the invention that is combinable or usable with one or more of the above aspects discloses a method of reducing a purchase price of a product. The method includes electronically associating a product to be purchased with a discount specific to the product to be purchased at a point of sale of the product but prior to purchase of the product. The product to be purchased is then associated with a customer and a total purchase price of products being purchased by the customer is calculated. A total purchase price is reduced by an amount of the discount specific to the product and the customer and the reduced total purchase price is collected from the customer at the point of sale.

Another aspect of the invention that is useable with one or more of the various features or aspects disclosed above, discloses an in-store electronic coupon delivery system. The system includes a first computer system having a processor, an input device, and an accessible connection with a database. The input device is configured to receive product information inputted by the purchaser and the processor is adapted to query the database for discount information associated with a particular product. An output is delivered to the consumer that identifies at least one of the particular product and the discount information. The output is receivable by an in-store checkout to verify purchase of a product and to effectuate reduction of a marked purchase price by an amount of a discount specific to the consumer and the product.

Another aspect of the invention that is useable with one or more of the various features and aspects disclosed above discloses an in-store system for discounting the purchase price of products. The system includes an indicator that is positioned proximate a product and configured to indicate the existence of a discount associated with the product. A coupon station is positioned in a retail location that contains the product and is configured to associate the product with a discount available for the product. The coupon station generates an output that associates at least two of a customer identity, products being purchased, and a discount amount associated with products being purchased. The system includes a checkout that is adapted to associate each product being purchased and a purchase price to calculate a gross sale price and interact with the output of the coupon station to generate a discounted sale price that is less then the gross sale price by the sum of the discounts for only each product having a discount.

In a preferred aspect, the various systems described above verifies or otherwise associates a specific discount value with respect to a retailer associated with the point of the sale of the given product. Preferably, only one or both of a retailer and a supplier are allowed to alter a characteristic, such as a value and/or a duration of validity of a discount specific to a particular product, prior to associating the product with the discount. More preferably, only the manufacturer can manipulate the value and/or the duration of a discount on a product. Still more preferably, one or both of the retailer and a supplier can manipulate the characteristics of a discount as a function of at least one of a current stock and a projected delivery date of more stock of a particular product. In a preferred aspect, a given product manufacturer can communicate or otherwise interact with the system to effectuate or alter the value of a discount and/or the duration of a discount and a retailer can interact with the system to manage inventory control and/or inventory or product availability information.

These and various other aspects and features of the present invention will be better appreciated and understood when considered in conjunction with the following detailed description and the accompanying drawings. It should be understood that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate one preferred embodiment presently contemplated for carrying out the invention. In the drawings:

FIG. 1 is a perspective view of a retail environment equipped with an in-store discount or coupon delivery system according to the present invention;

FIG. 2 is a schematic representation of the coupon station shown in FIG. 1;

FIG. 3 is a schematic representation of the integration of the coupon system according to the present invention within a retail environment of an exemplary operating sequence of the coupon system shown in FIG. 1;

FIG. 4 shows an exemplary discount calculation transaction sequence effectuated with the coupon delivery system shown in FIG. 1; and

FIG. 5 shows an exemplary checkout transaction sequence where a purchase price is reduced by an amount derived from the discount calculation transaction sequence shown in FIG. 4.

In describing the preferred embodiments of the invention that are illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose.

### DETAILED DESCRIPTION OF THE PREFERRED EMBODIMENT

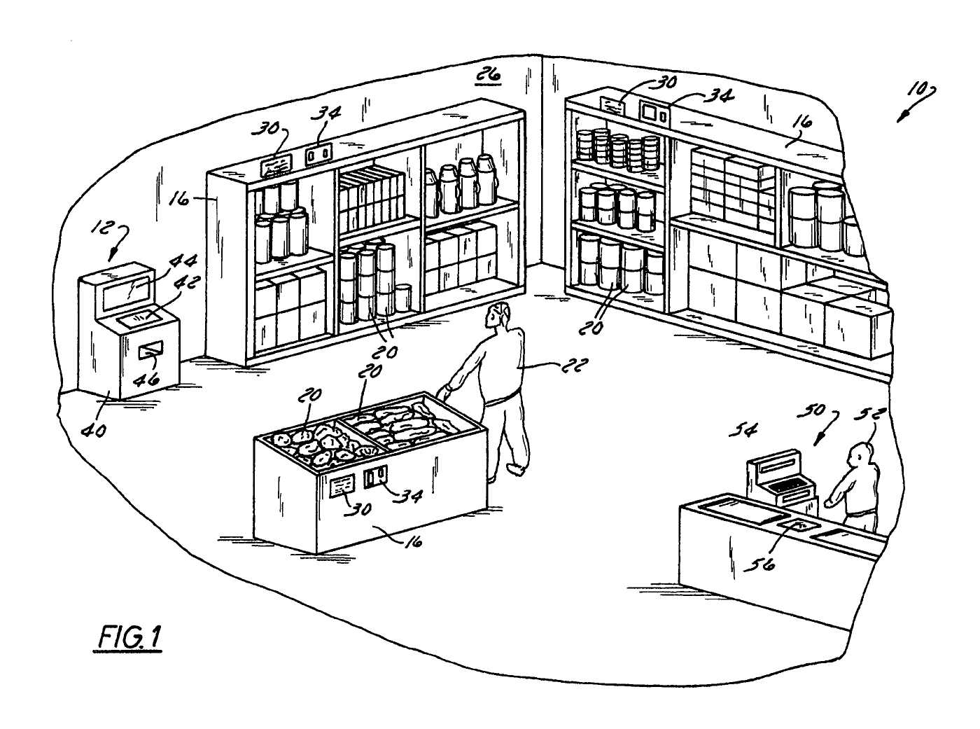

FIG. 1 shows an exemplary retail environment or retail location such as a grocery store or simply store 10 equipped with a coupon system 12 according the present invention. Although store 10 is shown as what is commonly understood as a grocery store, it is appreciated that store 10 could be configured as any retail environment associated with a point-of-sale of products or goods such as an apothecary, a drugstore, a hardware store, etc. Regardless of the specific configuration and/or materials or goods sold therein, store 10 includes one or more product displays 16 associated with showing produce, products, or goods 20 to customers 22. Commonly, displays 16 associated with produce 20 are spaced about a retail environment for facility 26 so that shoppers or customers 22 can efficiently navigate about the retail environment 26 during a shopping experience.

As used herein, the in-store retail environment general describes those facilities wherein patrons arrive, physically inspect and select desired goods, and pay for the goods prior to leaving the particular retail environment. Preferably, customers 22 are not required to have any particular identification or other permanently or temporarily maintain article that would indicate their ability to interact with coupon system 12. Preferably, any customer or consumer can interact with coupon system 12 in a manner that allows the customer, should they elect to take advantage of the opportunity, to reduce a gross collective goods price or cost by an amount associated with any available discounts for the products intended to be purchased by the consumer during a shopping event.

Signage 30 is commonly associated with each good 20 and positioned about facility 26 proximate the goods 20 so as to be readily available for inspection by customers 22 who may be interested in purchasing the particular goods 20. Signage 30 generally includes price, product description information, and or other information associated with a particular good 20 positioned thereat. An indicator 34 is provided on or near signage 30 as well as on the packaging or other non-consumable portion of the respective good 20 and indicates the availability of a discount or a coupon associated with the particular good 20. It is envisioned in indicator 34 provide information related to at least one or more of the existence of a discount, the origin of the discount, the amount of the discount, and a number of discounts available for the purchase a particular good such as limiting the discount to the first good purchased by the consumer and/or limiting the number of goods that can be discounted by the coupon such as “limit 3 per customer.” Positioning indicator 34 on a display well as on product 20 allows the consumer to readily visually identify those goods 20 that have an available discount as well as efficiently segregate the goods that have a discount from a total collection of goods being purchased during generation of a coupon as discussed further below.

A customer 22 intending to purchase a good 20 associated with an indicator 34 can proceed to a coupon station 40 associated with coupon system 12. Understandably, customer 22 can interact with coupon station 40 at any time or multiple times during a single shopping experience. Understandably, more than one coupon station 40 may be strategically distributed throughout a given retail environment and positioned to allow maximum customer interaction therewith a minimum of interference with the flow of non-using patrons therearound.

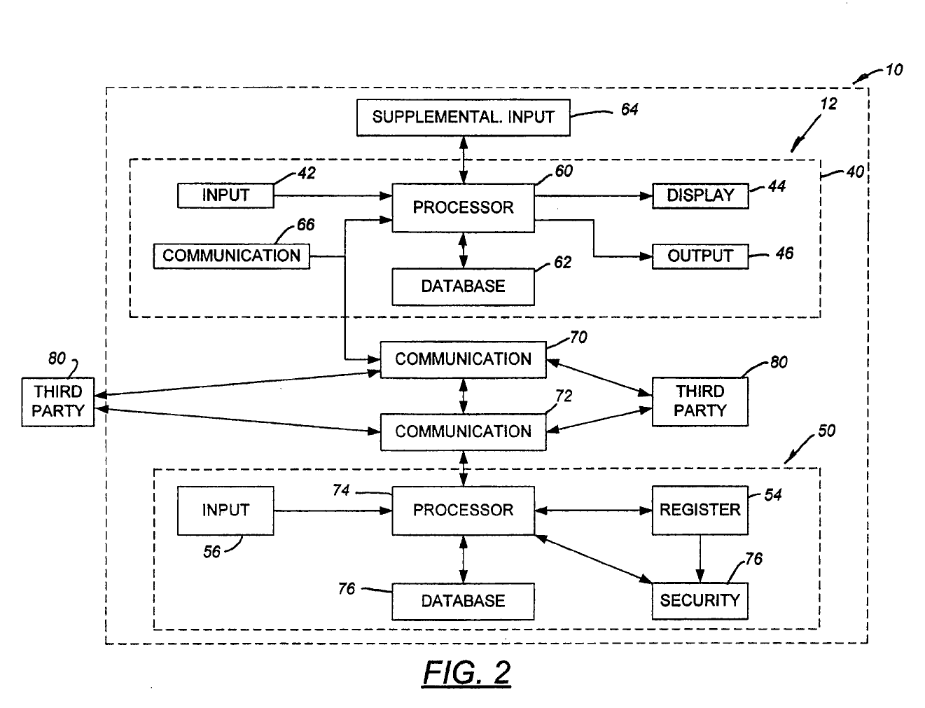

Referring to FIGS. 1 and 2, coupon station 40 includes an input 42, an optional display 44, and an output 46. Input 42 can be configured in any number of input devices such as an IR scanner, a barcode reader, a trackball or mouse device, a keyboard, and/or one or more buttons, tactile, audible, or visual input devices. Regardless of the operational modality, input 42 is configured to allow a customer 22 to interact with coupon station 40 and input information specific to a given product 20 thereto and to provide an indication of acceptance of a product specific discount and thereby the intention to purchase a given product. It is envisioned that input 42 be configured as a bar-code reader or other scanning device that automatically identifies a given product and a touch-screen or other feature that allows the customer to confirm their intention to purchase the intended product with the applicable discount. As mentioned above, providing an indicator 34 on the discounted products allows the consumer to readily identify and segregate those products that have a discount from those that do not during interaction with station 40.

Optional display 44 allows a customer 22 to visually confirm the existence, or non-existence, of a discount or coupon for a given product 20. It is further envisioned that display 44 communicate information regarding the amount of the discount to the customer. Understandably, there are those customers that are loyal to a particular brand or product regardless of price. Coupon system 12 allows such consumers the ability to take advantage of available discounts by simply “scanning” their intended purchases and receiving a discount value output associated therewith. The purchasing power of such consumers would be un-swayed by the information communicated via display 44.

Upon customer entry and confirmation of all the products 20 intended to be purchased and for which a discount is available, coupon station 40 generates an output 46 that associates one or more of a customer identity, a product, a discount available for the product, and/or a unique identifier identifying a collection of intended to be purchased products 20 and the applicable discount. It is appreciated that output 46 can be provided to the customer in a tangible media, provided in either or a combination of human readable and/or computer readable form, communicated directly to an in-store checkout, and/or communicated to other third parties beyond the customer and the retailer as discussed further below. Preferably, output 46 is at least one of delivered as a hard copy to customer 22 or communicated directly to a checkout system 50 of a retailer 10. Output 64 may further include a single indication of a discount amount and/or provide a human readable output that identifies each product being purchased and the discount associated therewith as well as sum of the applicable discounts.

Still referring to FIGS. 1 and 2, commonly during a checkout experience, a cashier 52 interacts with a register system 54 to provide an indication of the products being purchased and the value associated therewith. Check out 50 commonly includes an input 56, such as any of a keyboard, an IR scanner, barcode reader, or the like configured to assimilate each of the products purchased with pricing information associated therewith. As explained further below, upon completion of the checkout operation, and the customer tendering a monetary value associated with the products being purchased, the customers is free to leave facility 10 with the purchased products. However, on-site customers can elect to utilize coupon system 12 to reduce the gross or undiscounted price associated with the products being purchased.

Prior to the customer leaving facility 10 and tendering the requested amount, customer 22 can tender a coupon provided as output 46 and/or otherwise communicate with cashier 52 the intentions of reducing the total purchase price by a discount or coupon value associated with the various products being purchased. The purchase price calculated by cashier 52 can be reduced by the amount associated with the coupon value for the discounted products purchased by consumer 22. Upon tendering this reduced amount, customer 22 is free to leave a facility 10 with purchased products 20.

FIG. 2 is a graphical representation of coupon system 12 and checkout system 50 associated with facility 10. Coupon station 40 includes a processor 60 disposed between input 42 and display 44 and output 46. An optional database 62 is connected to processor 60 and can be periodically queried so as to maintain information germane or relevant to the existence of a coupon for a given product, the value, duration, and/or quantity associated with a given coupon, and/or product quantity and discount information.

Coupon station 40 preferably includes a supplemental input 64 or an optional communication link 66 that are adapted to allow configuration of processor 60 and/or manipulation of the information associated with database 62 of station 40. Such a configuration allows the output 46 of coupon station 40 to be associated with a date, product availability, customer information, and/or other data and/or cost information configured to assimilate a product being purchased with a valid price discount being associated therewith.

An optional communication interface 70, 72 can also be provided between coupon station 40 and checkout system 50. Checkout system 50 commonly includes a register 54 that can be selectively configured to communicate with a database 76 configured to assimilate and allow access to price and quantity information relative to purchasable products associated with facility 10. Processor 74 also communicates with an optional security system 77 configured to maintain the operational integrity of processor 70, database 76, as well as to assess produce and/or goods leaving facility 10 so as to confirm that those goods leaving the facility have been paid for.

Although it is envisioned that coupon station 40 can be directly managed by a individual retailer and/or product manufacturers, it is envisioned that a third party 80 be allowed to interact with coupon station 40 via either communication interface 70, 72, input 42 and/or supplemental input 64 so as to allow a third party to manipulate and/or manage information associated with database 62. Understandably, third-party 80 may be configured to communicate directly with coupon station 40 from a location within facility 10 and/or be allowed to wirelessly communicate therewith from locations remote from facility 10. Alternatively, it is envisioned that individual retailers, merchants, or product venders or manufactures manage and maintain coupon system 12. Alternatively, third party intermediaries may be positioned to manage coupon system 12 and interact with retailers and/or manufacturers.

It is further envisioned that system 12 be internet accessible, such as via any of communication interfaces 70, 72, to allow remote consumer inspection of discounts currently available via station 40. Understandably, as system 12 is fully supported at any individual retail site to discount the products sold thereat, consumers remotely accessing system 12 need only do so to interrogate the system with respect to currently available discounts and need not arrive at the retail environment with any particular identifier to benefit from the applicable discounts. Such a configuration reduces the potential for the presentation of counterfeit outputs from station 40 during a checkout sequence.

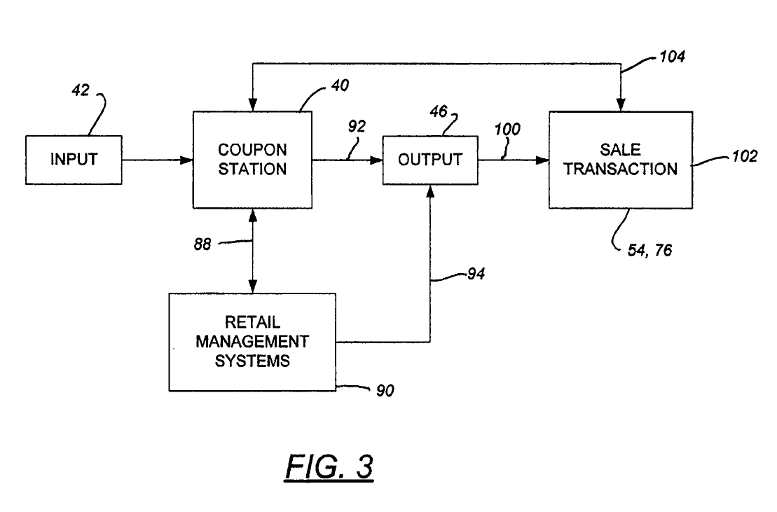

FIG. 3 shows an exemplary hierarchy associated with the operation of coupon station 40. Prior to a checkout sequence, customers 20 provide input information 42 to coupon station 40. Coupon station 40 can either independently verify the availability and/or validity of an applicable coupon available for a particular product and/or query 88 one or more of the components of the retail management system 90 such as processor 74, database 76, and/or third-party provider information 80 (FIG. 2).

During interaction with a customer 22, coupon station 40 generates output 46 that can optionally be validated with information 94 provided from retail management systems 90 and/or manufacturer information. After all of the intended products to be purchased have been input and/or validated with respect to coupon station 40 and the customer has indicated an acceptance of a given product and associated discount, output 46 generates a discount value 100 that can be communicated to customer 22 and/or checkout system 52 to effectuate a reduced price associated with a given sales transaction 102. An optional validation protocol 104 is provided between the register and/or security system 54, 56 associated with sales transaction 12 and validated with coupon station 40. Such an arrangement provides a security redundancy with respect to confirming that those products associated with output 46 are actually purchased during sales transaction 102.

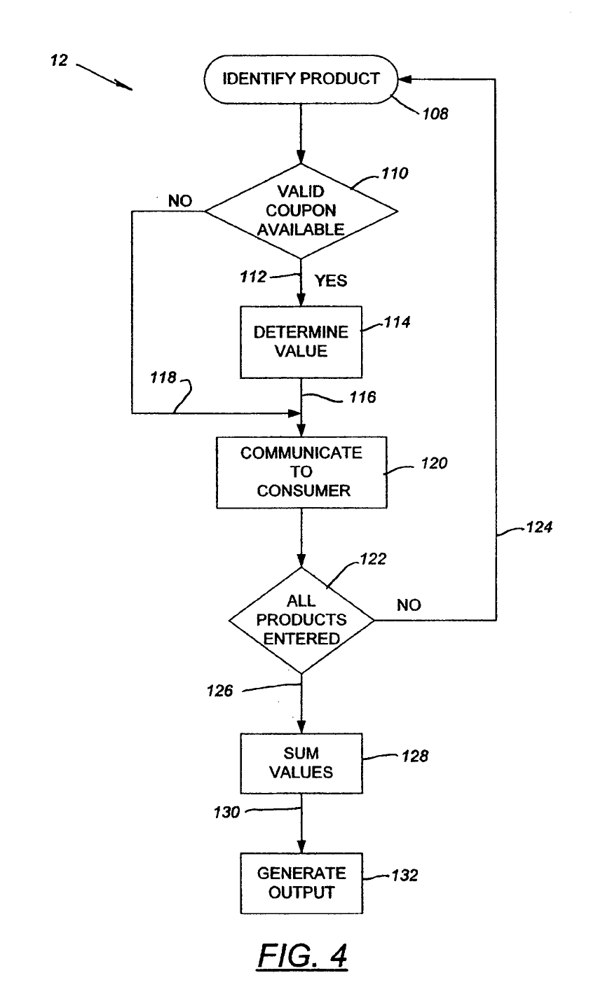

An exemplary operation sequence of coupon station 40 is shown graphically in FIG. 4. As a first step, coupon system 12 identifies a product 108 intended to be purchased. The product identity 108 is assimilated with any of a retailer's preferences, a manufacturer's preferences, a customer identity, current pricing information, and/or other desired variable parameters to assess whether a valid coupon is currently available 110 for the identified product 108. If a coupon is available 112, system 12 determines a value 114 associated with the coupon, or a discount amount. After the discount amount has been determined 116, or if a valid coupon is no longer available 118, system 112 optionally communicates to a consumer 120 any of the identity of the product, the current gross price of the product, the discount amount associated with the product, the discount amount associated with a product specific for a given customer, and/or other information which may be desirable and/or beneficial in persuading the consumers purchasing power from one product to another. System 12 can then either seek confirmation from the client regarding acceptance or rejection of the product with the corresponding discount and/or automatically assume agreement and intent to purchase the product and perform a purchase validation at checkout. Understandably, if the customer is dissatisfied and/or otherwise changes their mind regarding the discounted purchase price of the product and/or their preference for the particular product, system 12 disregards the discount attributable to non-selected products.

System 12 periodically queries the customer to assess whether all products have been entered 122 and identified by coupon system 12. System 12 continues to query a customer 124 for product information until all products that are intended to be purchased, and for which a discount may be available, have been identified 126. When all of a given customers products with available discounts have been identified and an available discount assigned 126, system 12 sums the available values 128 and precedes 130 to generate an output 132 that can be utilized to reduce the cost associated with the product(s) being purchased during a checkout event.

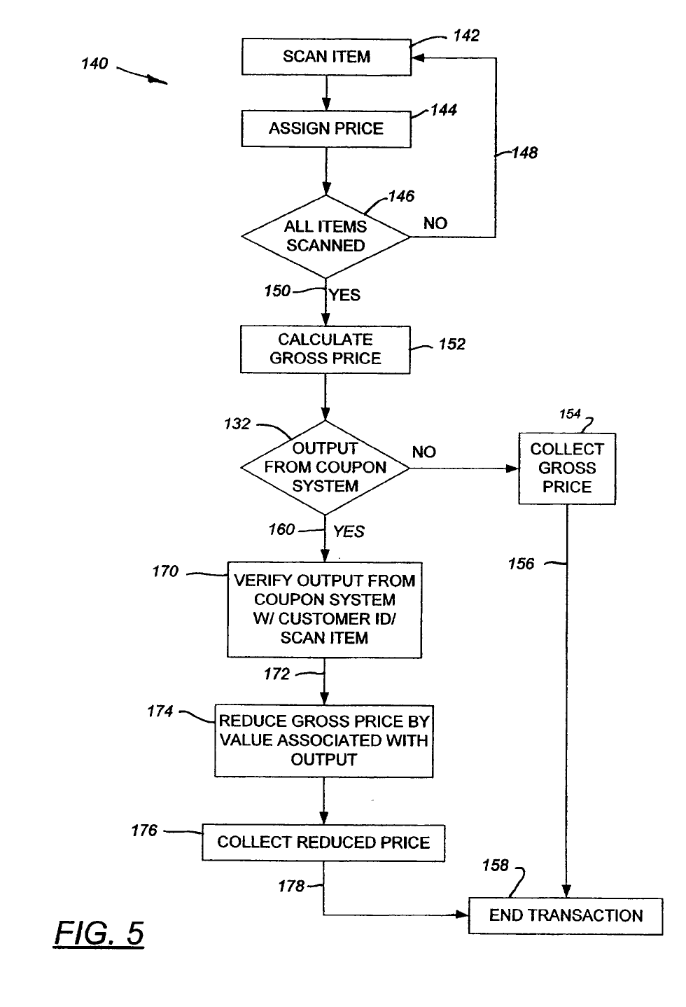

Referring to FIG. 5, during the checkout process 140, the customer provides all the products to be purchased to the cashier 52 and/or otherwise automated checkout system 50. Products being purchased are commonly scanned 142 and/or otherwise input or identified to register 54. Process 140 assigns a price 140 for each product being purchased 142 until all products have been identified 146, 142. After all items have been identified 150, system 40 calculates a gross price 152 associated with the un-discounted cost of the various items identified. System 140 determines whether an output 134 from coupon system 12 has been provided 132. If no output is provided 154, retailer 10 collects the gross price 154 as calculated at 152 and proceeds to close the sales transaction 156, 158.

If output 132 is available 160, system 140 optionally verifies output 132 with one or more of a customer ID, a product ID, a product brand, etc. 170. Preferably, system 140 verifies that those products associated with output 132 from coupon system 12 have been identified at step 142 of the checkout process 140. Upon verification that the products and/or amounts associated with output 132 correspond with the transaction being processed 172, system 140 reduces 174 the gross price calculated at 152 by a value associated with output 132. Upon collection of the reduced price 176, system 140 closes the reduced price sales transaction 178, 150. Preferably, system 140 is also configured to update one or mote of databases 62, 76 or coupon system 12 or retail system 50 to update stock on hand and/or other inventory information.

Coupon system 12 reduces the overhead expenses commonly attributable to dissemination of hardcopy coupon information. Coupon system 12 can also be configured to be fully autonomous with respect to the operation of retail system 50 thereby having only limited retail investment and avoiding reconfiguration of existing retail systems for integration with coupon system 12. For those so inclined to surrender management of coupon system 12 to third party provides, such third party providers can also provide unbiased information with respect to product movement rates, retail shopping flow information, and other product and/or location operational information. Preferably, coupon system 12 integrates information regarding material on hand or on order to coupon dispersal and collection rates to confirm coupon availability and validity. Coupon system 12 further prevents the undesired effects of redemption of invalid or no longer authorized coupon discount amounts thereby mitigating manufacturer and retailer losses attributable to such activities.

Therefore, one embodiment of the invention includes a method of reducing a purchase price of a product. The method includes electronically associating a product to be purchased with a discount specific to the product to be purchased at a point of sale of the product but prior to purchase of the product. The product to be purchased is then associated with a customer and a total purchase price of products being purchased by the customer is calculated. A total purchase price is reduced by an amount of the discount specific to the product and the customer and the reduced total purchase price is collected from the customer at the point of sale.

Another embodiment of the invention that is useable with one or more of the aspects of the above embodiment includes an in-store electronic coupon delivery system having a first computer system having a processor, an input device, and an accessible connection with a database. The input device is configured to receive product information inputted by the purchaser and the processor is adapted to query the database for discount information associated with a particular product. An output is delivered to the consumer that identifies at least one of the particular product and the discount information. The output is receivable by an in-store checkout to verify purchase of a product and to effectuate reduction of a marked purchase price by an amount of a discount specific to the consumer and the product.

Another embodiment of the invention useable with one or more of the aspects or embodiments disclosed above includes an in-store system for discounting the purchase price of products. The system includes an indicator that is positioned proximate a product and configured to indicate the existence of a discount associated with the product. A coupon station is positioned in a retail location that contains the product and is configured to associate the product with a discount available for the product. The coupon station generates an output that associates at least two of a customer identity, products being purchased, and a discount amount associated with products being purchased. The system includes a checkout that is adapted to associate each product being purchased and a purchase price to calculate a gross sale price and interact with the output of the coupon station to generate a discounted sale price that is less then the gross sale price by the sum of the discounts for only each product having a discount.

The present invention has been described above in terms of the preferred embodiment. It is recognized that various alternatives and modifications may be made to these embodiments which are within the scope of the appending claims.

What is claimed is:

1. A method of reducing a purchase price of a product, the method comprising:
electronically associating a product to be purchased with a discount specific to the product to be purchased at a point of sale of the product but prior to purchase of the product;
associating the product to be purchased with a customer;
calculating a total purchase price of products being purchased by the customer;
reducing the total purchase price by an amount of the discount specific to the product and the customer; and
collecting a reduced total purchase price from the customer at the point of sale.

2. The method of claim 1 further comprising providing a coupon receipt that identifies at least one of the product and the customer to the customer prior to calculating the total purchase price at the point of sale.

3. The method of claim 1 further comprising verifying the discount specific to the product with respect to a retailer associated with the point of the sale.

4. The method of claim 3 further comprising allowing at least one of the retailer and a supplier to alter at least one of a value and a duration of validity of the discount specific to the product prior to associating the product with the discount.

5. The method of claim 4 further comprising allowing the retailer to alter at least one of the value and the duration of validity of the discount as a function of at least one of a current stock and a projected delivery date of more stock of the product.

6. The method of claim 3 further comprising providing an indication of an existence of a discount at a display location of the product.

7. The method of claim 6 further comprising allowing the customer to enter identification of the product prior to purchase.

8. The method of claim 1 further comprising comparing inventory data to non-discounted sales of the product and discounted sales of the product.

9. An in-store electronic coupon delivery system comprising:
a first computer system including a processor, an input device, and an accessible connection with a database, the input device being configured to receive product information inputted by a purchaser and the processor being adapted to query the database for discount information associated with a particular product; and
an output delivered to the purchaser that identifies at least one of the particular product and discount information, the output being receivable by an in-store checkout to verify purchase of a product and to effectuate reduction of a marked purchase price by an amount of a discount specific to the purchaser and the product.

10. The system of claim 9 further comprising an indicator positioned proximate a display of the product that indicates existence of a discount associated with the product.

11. The system of claim 10 wherein the indicator includes a discount amount.

12. The system of claim 10 wherein the discount is specific to the product and a given retailer.

13. The system of claim 9 wherein the output is in computer readable form for inputting into a second computer associated with the in-store checkout.

14. The system of claim 13 wherein a discount is applied one of during or after the in-store checkout.

15. An in-store system for discounting the purchase price of products comprising:
an indicator positioned proximate a product and configured to indicate the existence of a discount associated with the product;
a coupon station positioned in a retail location and configured to associate the product with a discount available for the product, the coupon station generating an output that associates at least two of a customer identity, products being purchased, and a discount amount associated with each product being purchased; and
a checkout adapted to associate each product being purchased and a purchase price to calculate a gross sale price and interact with the output of the coupon station to generate a discounted sale price that is less then the gross sale price by a sum of the discounts for only each product having a discount.

16. The system of claim 15 wherein the coupon station limits a number of discounts available for a particular product.

17. The system of claim 16 further comprising limiting the number of discounts available for a particular product based on the customer identity.

18. The system of claim 15 further comprising an electronic communication network configured to allow in-store communication between the coupon station and the checkout.

19. The system of claim 18 wherein the coupon station can communicate with other coupon stations located at least one of in the retail location and at other retail locations.

20. The system of claim 15 wherein the coupon station is controlled by a third party entity distinct from a retailer and a supplier of the product and at least one of the retailer and the supplier communicates with the third party entity to determine each discount.
